(19) United States
(12) Patent Application Publication
(10) Pub. No.: US 2003/0218082 A1
(43) Pub. Date: Nov. 27, 2003

(54) Irrigation nozzle

(75) Inventor: David Boyce Malcolm, Coarsegold, CA (US)

Correspondence Address: Kevin W. Guynn, SONNENSCHEIN NATH & ROSENTHAL, Wacker Drive Station, Sears Tower, P.O. Box #061080, Chicago, IL, 60606-1080, US

(73) Assignee: Full Coverage Irrigation, Inc.

(21) Appl. No.: 10/152,084

(22) Filed: May 21, 2002

(51) Int. Cl. B05B 1/00

(52) U.S. Cl. 239/589

(57) ABSTRACT

A nozzle is provided for use with a fluid discharge conduit to disperse a fluid flowing through the fluid discharge conduit in a stream. The nozzle includes an orifice housing having a first end for connection to the fluid discharge conduit, a second end with an orifice therein and a communicating passage therethrough to permit the fluid stream to enter from the fluid discharge conduit and to exit from the orifice housing. The communicating passage has a first diameter at the first end adjacent to the fluid discharge conduit and a step formed therein spaced a distance from the orifice to provide a diameter less than the first diameter.

### BACKGROUND OF THE INVENTION

The invention relates primarily to nozzles, and in particular to an irrigation nozzle.

Nozzles for irrigation systems are well known and a state of the art nozzle is disclosed in U.S. Pat. No. 4,346,848, incorporated herein by reference. In the nozzle disclosed in that patent, an orifice housing is threaded into the discharge end of a sprinkler and an orifice plate is pressed fit or staked into the orifice housing. That patent describes various configurations of the orifice plate which provide improved water distribution.

Improved water distribution from the nozzle would provide that the amount of water per unit area would be directly proportional to the distance from the sprinkler. In attempting to achieve the most effective distribution pattern, it would be preferred if the water pressure supplied to the sprinkler could be reduced, in order to reduce the power requirements of the irrigation system. It is also preferred to increase a water droplet size from the nozzle in order to improve the usefulness of the water for irrigation purposes. Extremely small droplets result in water vaporizing and failing to reach the ground and very small droplet size results in the water evaporating as it lies on the ground before it can penetrate the soil.

While the invention disclosed in U.S. Pat. No. 4,346,848 provided an improved nozzle for irrigation, it would be beneficial if there were provided a nozzle which would deliver the stream of water further from the nozzle, or with more uniformity, without increasing the pressure of the water supply to the nozzle.

### SUMMARY OF THE INVENTION

The present invention yields an improved water distribution in terms of distributing water further from the nozzle and with greater uniformity than prior nozzles, without increasing the water pressure supplied to the nozzle. At least one internal step, which may be in the form of a raised ring, is provided in the orifice housing, in the water passage leading to the orifice plate. It is believed that this step creates a turbulence around the outside of the water stream as it approaches the orifice plate which slows down the outside of the stream, more effectively stripping water from the outer core of the stream as it flows through the slots of the orifice plate.

### BRIEF DESCRIPTION OF THE DRAWING

FIG. 1 is a side view, partly in section and partly in elevation, of a first embodiment of the nozzle of the present invention.

FIG. 2 is a side view, partly in section and partly in elevation, of a second embodiment of the nozzle of the present invention.

FIG. 3 is a side view, partly in section and partly in elevation, of a third embodiment of the nozzle of the present invention.

FIG. 4 is a graphical illustration of a water distribution pattern for a prior art nozzle.

FIG. 5 is a graphical illustration of a water distribution pattern for a nozzle embodying the principles of the present invention, and of the first embodiment type of FIG. 1.

### DETAILED DESCRIPTION OF THE PREFERRED EMBODIMENT

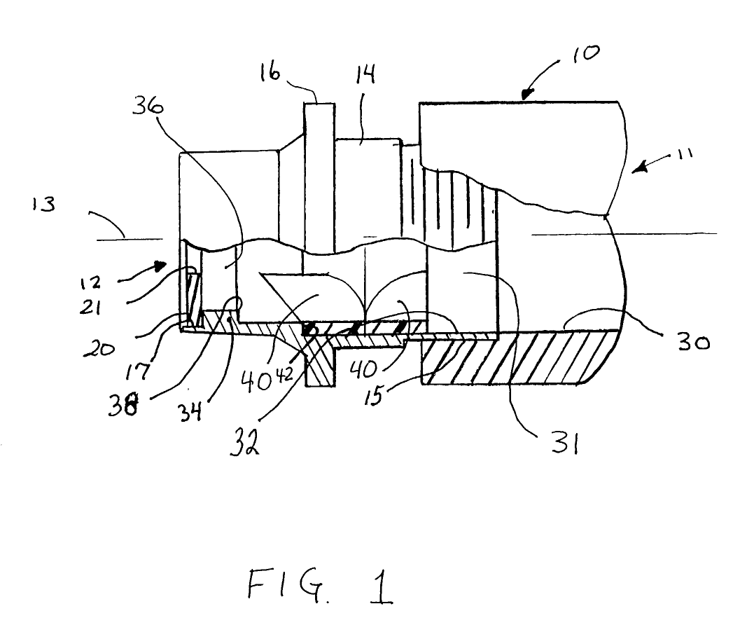

FIG. 1 shows a discharge end 10 of a sprinkler, especially of an impulse rotating sprinkler. Impulse rotating sprinklers are well known in agricultural and residential use. Although the nozzle of the present invention is designed primarily for impulse rotating sprinklers, the nozzle has other applications in other types of sprinklers, and it may also be used for distribution of other fluids.

The discharge end 10 of the sprinkler delivers fluid from a source of fluid from an upstream end 11 to a downstream end 12 in a fluid stream along a predetermined path substantially concentric to a longitudinal axis 13 of the substantially cylindrical discharge end 10 of the sprinkler. A nozzle or orifice housing 14 may be threaded into the discharge end 10 via mating threads 15 and a hex projection 16 of the orifice housing 14 facilitates threading and tightening the orifice housing 14 into the discharge end 10 of the sprinkler. Other types of connections between the discharge end 10 and the orifice housing 14, including bayonet, friction fit, set screws, and adhesives, and other connections as are known in the art could also be utilized.

An orifice plate 20 with an orifice 21 therethrough is mounted in the downstream end 12 of the orifice housing 14. The orifice plate 20 is pressed fit or staked into the orifice housing 14 and fits in a groove 17 of the orifice housing 14. The particular configuration of the orifice 21 and the shape of the orifice plate 20 can vary and may include any one of the shapes described in U.S. Pat. No. 4,346,848, or other shapes. The orifice may also be formed in an end wall formed integrally with the orifice housing 14, in the location of the orifice plate 20. If a separate orifice plate is used, it can be formed of a different material than the orifice housing, particularly for wear and cost considerations.

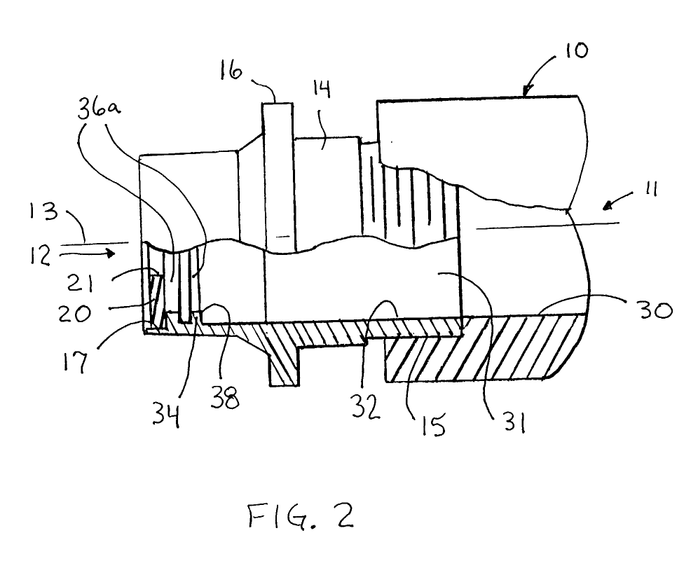

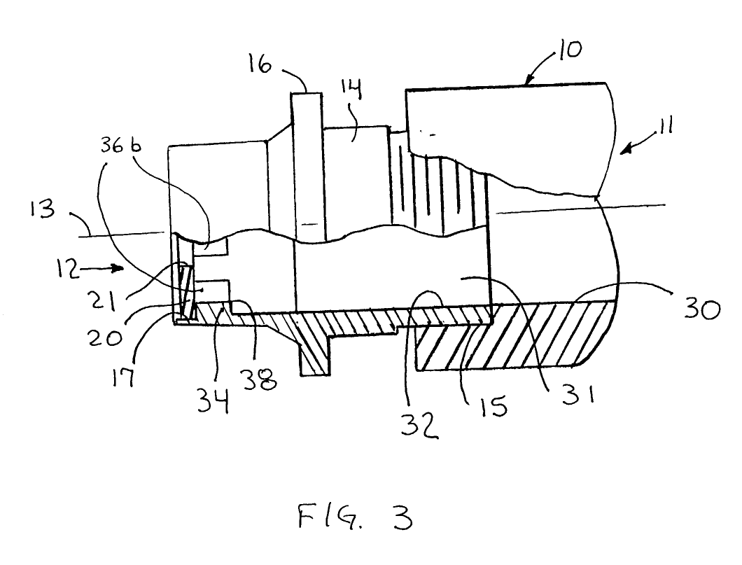

The liquid to be dispensed by the nozzle flows through an interior of the discharge end which is bounded by an interior surface 30 substantially parallel with the longitudinal axis 13, thus providing a generally cylindrical chamber 31. While a generally circular cylindrical chamber 31 yields the highest inner stream velocity and is easiest to form in a metal orifice housing 14, other shapes could be provided This surface 30 has a diameter substantially identical to an interior cylindrical surface 32 formed at an upstream end of the orifice housing 14. Thus, liquid flowing from the discharge end 10 into the orifice housing 14 will proceed substantially unhindered. As the fluid approaches the orifice plate 20, there is a step 34 provided in the interior of the orifice housing 14 which reduces the internal diameter of the passage through the orifice housing. The step shown in FIG. 1 is a single continuous ring 36 extending around the interior circumference of the orifice housing 14. Alternatively, as shown in FIG. 2, there may be provided a plurality of rings 36a as the step 34. Further, as shown in FIG. 3, there may be provided a discontinuous ring 36b as the step. Other turbulence creating structures could be used as well for the step 34. The single ring of FIG. 1 is the easiest to form in a metal orifice housing 14.

While the size and placement of the step 34 may vary, it has been found that in an orifice housing 14 having an internal diameter at surface 32 of 0.555 inches, the step 34 preferably has an internal radial dimension, or height, in the range of 0.015 to 0.045 inches. The particular dimension selected depends on the orifice plate diameter and the intended water pressure at the sprinkler. Also, a leading edge 38 of the step 34 may be positioned a distance from the orifice plate 20 selected to provide the most effective and desired range for the water spray. In the particular size orifice housing described above, a distance of 0.109 inches provides a beneficial result.

If desired, stream straighteners 40, as are known in the art, can be placed in the interior of the orifice housing 14 in the chamber 31, to hold a center of the stream together, even though a turbulence is created at an outside of the stream due to the presence of the step 34. A shoulder 42 may be provided for the stream straightener to abut against, thereby avoiding the need for separate fasteners.

In tests of a nozzle incorporating the principles of the present invention, that is, with the use of the internal step, compared to a previously available nozzle without such a step, the water distribution pattern was improved according to the following charts.

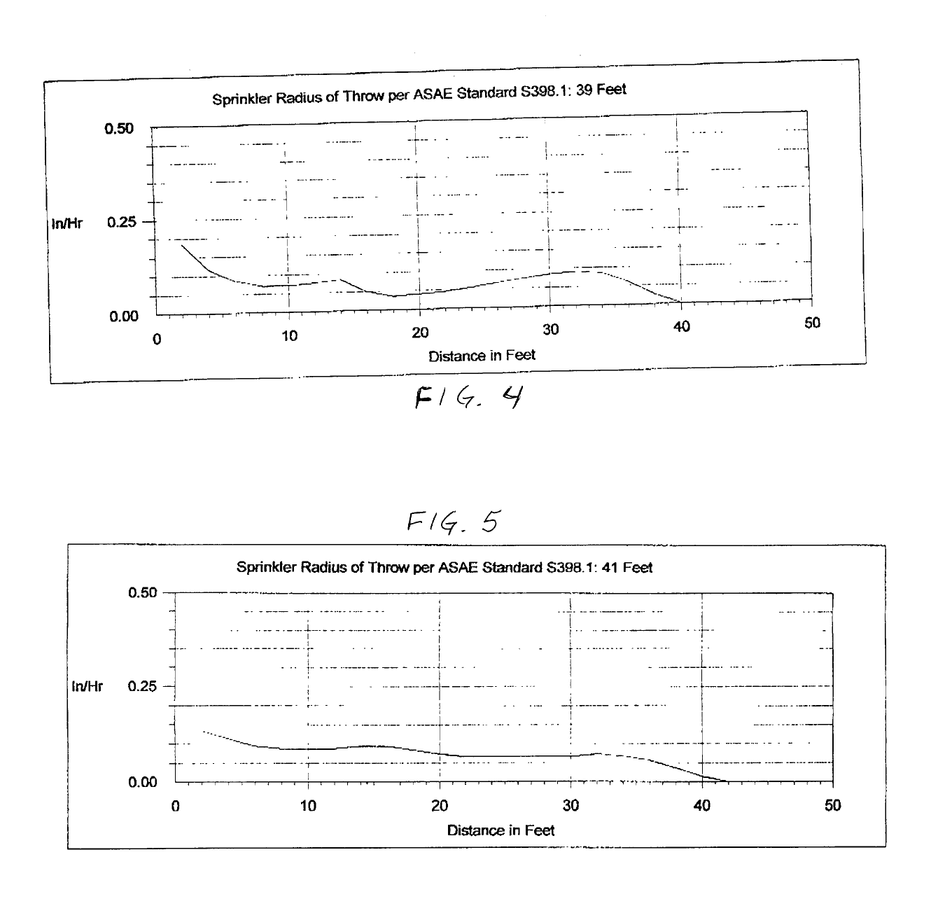

The first chart listed below and graphically illustrated in FIG. 4 shows the results of a standard prior art nozzle. The amount of water collected at various listed distances from the nozzle, per hour with a nozzle size of 9/64″ and a water flow rate of 2.9 gallons per minute, with a pressure of 30 PSI is listed.

| | | | |
|---|---|---|---|
| 2.0′ = 0.185 | 14.0′ = 0.083 | 26.0 = 0.065 | 38.0′ = 0.025 |
| 4.0′ = 0.115 | 16.0′ = 0.050 | 28.0′ = 0.075 | 40.0′ = 0.003 |
| 6.0′ = 0.085 | 18.0′ = 0.035 | 30.0′ = 0.085 | |
| 8.0′ = 0.070 | 20.0′ = 0.040 | 32.0′ = 0.090 | |
| 10.0′ = 0.070 | 22.0′ = 0.045 | 34.0′ = 0.085 | |
| 12.0′ = 0.075 | 24.0′ = 0.055 | 36.0′ = 0.060 | |

The second chart listed below and graphically illustrated in FIG. 5 shows the results of a nozzle as shown in FIG. 1, embodying the principles of the present invention. The amount of water collected at various listed distances from the nozzle, per hour with the same size nozzle, water flow rate and pressure as in chart 1 is listed.

| | | | |
|---|---|---|---|
| 2.0′ = 0.133 | 14.0′ = 0.093 | 26.0 = 0.067 | 38.0′ = 0.037 |
| 4.0′ = 0.113 | 16.0′ = 0.093 | 28.0′ = 0.067 | 40.0′ = 0.013 |
| 6.0′ = 0.093 | 18.0′ = 0.083 | 30.0′ = 0.067 | |
| 8.0′ = 0.087 | 20.0′ = 0.073 | 32.0′ = 0.073 | |
| 10.0′ = 0.087 | 22.0′ = 0.067 | 34.0′ = 0.067 | |
| 12.0′ = 0.087 | 24.0′ = 0.067 | 36.0′ = 0.057 | |

As seen, the results with a nozzle embodying the principles of the present invention are much more consistent throughout the range, and in fact, the nozzle embodying the principles of the present invention had a radius of throw 2 feet further than the prior art nozzle. With a more uniform pattern throughout the range, the results of the plants being watered will also be more uniform and areas of over watering will be avoided as will areas of under watering.

The present invention has been described utilizing particular embodiments. As will be evident to those skilled in the art, changes and modifications may be made to the disclosed embodiments and yet fall within the scope of the present invention. The disclosed embodiments are provided only to illustrate aspects of the present invention and not in any way to limit the scope and coverage of the invention. The scope of the invention is therefore only to be limited by the appended claims.

The embodiments of the invention in which an exclusive property or privilege is claimed are defined as follows:

1. A nozzle for use with a fluid discharge conduit to disperse a fluid flowing through the fluid discharge conduit in a stream, comprising:
an orifice housing having a first end for connection to the fluid discharge conduit, a second end with an orifice therein and a communicating passage therethrough to permit the fluid stream to enter from the fluid discharge conduit and to exit from said orifice housing;
said communicating passage having a first diameter at said first end adjacent to the fluid discharge conduit; and
said communicating passage having a step formed therein spaced a distance from said orifice to provide a diameter less than said first diameter.

2. A nozzle according to claim 1, wherein said step is formed as a single continuous ring.

3. A nozzle according to claim 1, wherein said step is formed as a plurality of rings.

4. A nozzle according to claim 1, wherein said step is formed as a discontinuous ring.

5. A nozzle according to claim 1, wherein said step reduces said first diameter by an amount of 0.015 to 0.045 inches.

6. A nozzle according to claim 1, wherein said orifice is provided in a separate orifice plate secured in said orifice housing.

7. A nozzle according to claim 1, wherein said passage is cylindrical and parallel to a longitudinal axis of the fluid discharge conduit.

8. A nozzle according to claim 7, wherein said step is cylindrical and extends around an entire interior periphery of said passage.

9. A nozzle according to claim 1, wherein at least one stream straightener is provided in said passage, upstream of said step.

10. A nozzle according to claim 1, wherein said orifice housing has an exterior portion with threads thereon to facilitate connection to said fluid discharge conduit.

11. A nozzle for use with a fluid discharge conduit to disperse a fluid flowing through the fluid discharge conduit in a stream, comprising:
an orifice housing having a first end for connection to the fluid discharge conduit, a second end with an orifice therein and a communicating passage therethrough to permit the fluid stream to enter from the fluid discharge conduit and to exit from said orifice housing;
said communicating passage having a first diameter at said first end adjacent to the fluid discharge conduit; and
said communicating passage having a step formed therein to provide a diameter less than said first diameter by an amount of 0.015 to 0.045 inches.

12. A nozzle according to claim 11, wherein said step is formed as a continuous ring.

13. A nozzle according to claim 11, wherein said step is formed as a discontinuous ring.

14. A nozzle according to claim 11, wherein said orifice is provided in a separate orifice plate secured in said orifice housing.

15. A nozzle according to claim 11, wherein said passage is cylindrical and parallel to a longitudinal axis of the fluid discharge conduit.

16. A nozzle according to claim 15, wherein said step is cylindrical and extends around an entire interior periphery of said passage.

17. A nozzle according to claim 11, wherein at least one stream straightener is provided in said passage, upstream of said step.

18. A nozzle according to claim 11, wherein said orifice housing has an exterior portion with threads thereon to facilitate connection to said fluid discharge conduit.

19. A nozzle for use with a fluid discharge conduit to disperse a fluid flowing through the fluid discharge conduit in a stream, comprising:
an orifice housing having a first end for connection to the fluid discharge conduit, a second end with a separate orifice plate having an orifice therein secured thereto and a cylindrical communicating passage therethrough arranged parallel to a longitudinal axis of the fluid discharge conduit to permit the fluid stream to enter from the fluid discharge conduit and to exit from said orifice housing;
said communicating passage having a first diameter at said first end adjacent to the fluid discharge conduit; and
said communicating passage having a cylindrical step in the shape of a continuous ring formed therein extending around an entire interior periphery of said passage to provide a diameter less than said first diameter by an amount of 0.015 to 0.045 inches.

20. A nozzle according to claim 19, wherein at least one stream straightener is provided in said passage, upstream of said step.
